(19) United States
(12) Patent Application Publication
(10) Pub. No.: US 2011/0238858 A1
(43) Pub. Date: Sep. 29, 2011

(54) TRAFFIC SHAPING DEVICE

(75) Inventor: TAKAHIRO SAGARA, Ebina (JP)

(73) Assignee: Hitachi, Ltd.

(21) Appl. No.: 12/987,938

(22) Filed: Jan. 10, 2011

(30) Foreign Application Priority Data
Mar. 23, 2010 (JP) 2010-065430

(51) Int. Cl. G06F 15/16

(52) U.S. Cl. 709/232

(57) ABSTRACT

When communication traffic between communication devices is shaped by a relay device on a network, the communication speed of a transport layer is prevented from being dramatically reduced as compared to the shaped traffic on a network with a high error rate. On the basis of the SID of data received from a communication device and a data size, a relay device predicts the SID expected to be received for the next time in the same communication, compares the predicted SID with another SID included in data received for the next time, and releases the shaped traffic for the data if the received SID is smaller than the predicted SID. Further, when consecutively receiving a given number or larger of pieces of data which are larger than the predicted SID, the relay device releases the shaped traffic for the data.

### INCORPORATION BY REFERENCE

This application claims priority based on a Japanese patent application, No. 2010-065430 filed on Mar. 23, 2010, the entire contents of which are incorporated herein by reference.

### BACKGROUND

The subject matter discussed herein relates to a traffic shaping technique provided for a relay device installed on a communication path in a server or between a terminal and a server in a network system such as WWW (World Wide Web) in which communications are performed between a server and a terminal.

There is known a subscription system in which a network is subscribed on a planned-traffic basis and can be used at a fixed price within the subscribed traffic.

In such a subscription, it is desirable for a network provider to control communications so as not to exceed the subscribed traffic, and it is desirable for a user to be able to communicate at the upper limit of the subscribed traffic.

As an example of a traffic shaping device, US Patent Application Laid-Open No. 2006/268,719 proposes a method in which a relay device determines the transmission timing of data on the basis of the token bucket algorithm or the leaky bucket algorithm, the guaranteed minimum traffic is secured, and the traffic is restricted within the maximum allowable traffic.

In a protocol such as TCP/IP, when a segment (the name of a data block in a transport layer) transmitted by a terminal is lost on a network, the terminal detects the lost of the segment and transmits the same.

In general, traffic shaping restricts communication traffic in a network layer while the amount of data to be relayed in a certain period of time is suppressed to a specified value or smaller as described in US Patent Application Laid-Open No. 2006/268,719, and thus the traffic shaping device suppresses transmission of data to the limited traffic or smaller, irrespective of whether or not the segment has been retransmitted.

Therefore, in a network with low quality where segments are frequently retransmitted due to lost segments, communication traffic in a transport layer is deteriorated as compared to the specified (subscribed) traffic.

Further, on reception of segments which are not in order, a reception-side device transmits duplicate acknowledgements. On reception of a given number or larger of duplicate acknowledgements, a transmission-side device determines that the segment has been lost (referred to as Fast Retransmit). However, if the traffic shaping device restricts the communication traffic, reception of the segments which are not in order by the reception-side device is delayed. As a result, reception of the duplicate acknowledgements by the transmission-side device is delayed. Thus, detection of the lost segment is accordingly delayed, and the communication traffic of a transport layer is further deteriorated.

Therefore, there is a possibility that a user cannot communicate at the upper limit of the subscribed traffic.

### SUMMARY

In TCP, the transmission-side device transmits a segment while including information of the order, and the reception-side device transmits an acknowledgement including order information of the segment which is expected to be received for the next time from the transmission-side device.

In an example of a traffic shaping function disclosed in below, it is assumed that when the transmission-side device consecutively receives a predetermined number or larger of acknowledgements including the same sequence ID (hereinafter, abbreviated as SID), segments subsequent to the SID are retransmitted.

The relay device calculates the SID of the segment predicted to be received for the next time in each connection, and stores the same as a predicted SID.

When the traffic shaping function receives the next segment in the same connection, the predicted SID is compared with the SID of the received segment. If the SID is smaller than the predicted SID, the segment is determined as a retransmitted segment, and is transmitted to the reception-side device without shaping the traffic thereof. Accordingly, it is possible to prevent excessive communication traffic shaping even for the retransmitted segment by the traffic control shaping.

Further, when consecutively receiving a given number or larger of segments whose SIDS are larger than the predicted SID, the segment having the predicted SID is determined as being lost, and are transmitted to the reception-side device without shaping the traffic of the segments whose SIDs are larger than the predicted SID.

In another example of the disclosed traffic shaping function, it is assumed that when the transmission-side device consecutively receives a predetermined number or larger of acknowledgements having the same SID, the segment having the SID is retransmitted, and thereafter, transmission of the segment subsequent to one transmitted before retransmission is resumed.

The relay device refers to the SID and size of the received segment in each connection, calculates the range of the received segment as a received section, and stores the same while coupling to the previous received-section.

If the traffic shaping function receives the next segment in the same connection, the received section is compared with the SID of the received segment. If the SID is within the received section, the segment is determined as a retransmitted segment, and is transmitted to the reception-side device without shaping the traffic thereof. Accordingly, it is possible to prevent excessive communication traffic shaping even for the retransmitted segment by the traffic control shaping.

Further, when the SID of the received segment is out of the received section and is equal to or smaller than the received section, the segment is determined as a retransmitted segment and a target for the traffic shaping, and is transmitted to the reception-side device earlier than other segments in a hold queue.

Accordingly, the acknowledgement of the reception-side device by which the lost segment is requested is promptly transmitted to the transmission-side device. Thus, detection and retransmission of the lost segment by the transmission-side device can be prevented from being delayed due to the traffic shaping, and as a result, the communication traffic can be prevented from being excessively shaped.

According to the above-described aspects, in communications in a network with a high error rate, communication traffic in a transport layer can be close to the specified traffic.

According to the teaching herein, communications can be performed in traffic closer to the subscribed traffic.

These and other benefits are described throughout the present specification. A further understanding of the nature and advantages of the disclosed traffic shaping may be realized by reference to the remaining portions of the specification and the attached drawings.

### BRIEF DESCRIPTION OF THE DRAWINGS

The disclosed traffic shaping will become fully understood from the detailed description given hereinafter and the accompanying drawings, wherein:

FIG. 1 shows an example of a configuration diagram of a relay device according to a first embodiment;

FIG. 2 shows an example of a configuration diagram of an information processing device used as the relay device according to the first embodiment;

FIG. 3 shows an example of a flowchart for processing a segment received by the relay device according to the first embodiment from a source communication device;

FIG. 4 shows a sequence example in the case where a segment is lost between a terminal and the relay device in communications among the relay device according to the first embodiment, the server, and the terminal;

FIG. 5 shows a sequence example in the case where a segment is lost between the relay device and the server in communications among the relay device according to the first embodiment, the server, and the terminal;

FIG. 6 shows an example of a configuration diagram of a relay device according to a second embodiment;

FIG. 7 shows an example of a flowchart for processing a segment received by the relay device according to the second embodiment from a source communication device;

FIG. 8 shows an example of a configuration diagram of a relay device according to a third embodiment;

FIG. 9 shows an example of a configuration diagram of a relay device according to a fourth embodiment;

FIG. 10 shows a sequence example in the case where a segment is lost between the terminal and the relay device in communications among the relay device according to the second embodiment, the server, and the terminal;

FIG. 11 shows a sequence example in the case where a segment is lost between the relay device and the server in communications among the relay device according to the second embodiment, the server, and the terminal; and

FIG. 12 shows a sequence example in the case where a segment is lost between the relay device and the server in communications among the relay device according to the third embodiment, the server, and the terminal.

### DETAILED DESCRIPTION OF THE EMBODIMENT

Hereinafter, embodiments of the present invention will be described with reference to the drawings.

In the respective embodiments below, there will be described a case in which a relay device on a network is provided with a traffic shaping function. However, a server may be provided with the traffic shaping function.

In the description of the respective embodiments, TCP is used as a protocol of a transport layer and a sequence number of TCP is used as an SID. However, other protocols as similar to TCP may be used as long as connection-type communications are performed and each segment has order information of data corresponding to a sequence number of TCP as an SID.

For example, in TCP, the transmission-side device transmits a segment while including an SID, and the reception-side device transmits an acknowledgement while including the SID of the segment expected to be received for the next time from the transmission-side device as an acknowledgement number.

Further, in the description of the respective embodiments below, a repay device on a network is provided with a traffic shaping function. However, respective processing units and storing units included in the traffic shaping function may be included in another device which is physically coupled though a network.

Further, in the respective embodiments below, the relay device performs the traffic shaping for communications from a server to a terminal (namely, the server serves as a transmission-side device and the terminal serves as a reception-side device). On the contrary, the relay device may control communications from a terminal to a server, or may control communications of both directions.

### First Embodiment

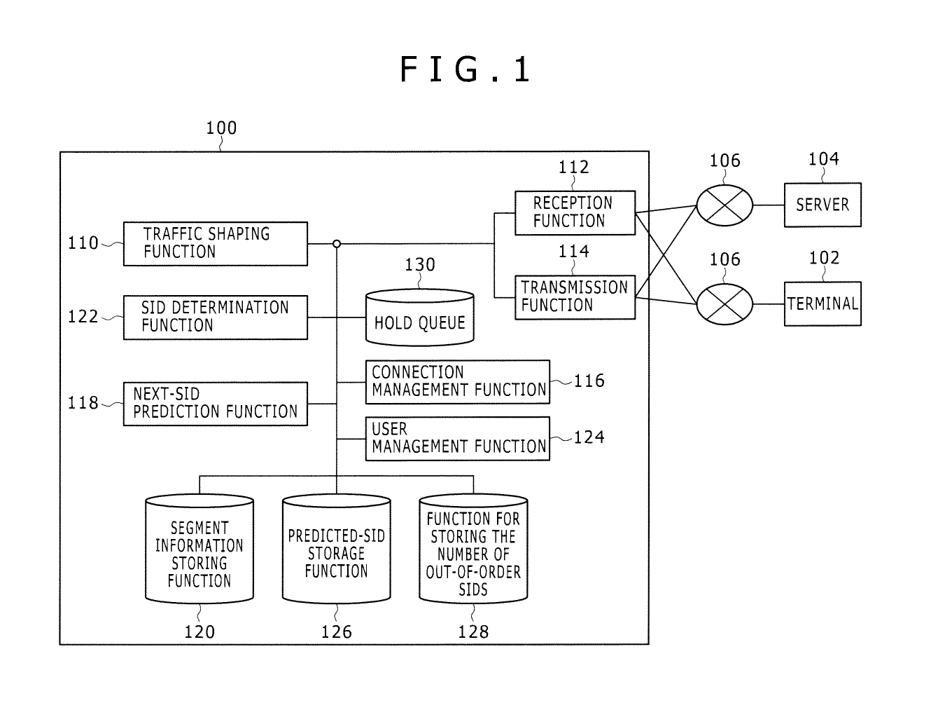

As shown in FIG. 1, a communication system of the embodiment includes a terminal 102 which receives data from a server while using TCP as a communication protocol for a transport layer, a server 104 which transmits data to the terminal while using the same communication protocol, and a relay device 100 which relays and controls communications between the terminal 102 and the server 104 on a network 106 such as the Internet. The terminal 102, the server 104, and the relay device 100 may be provided in plural.

It should be noted in the embodiment that the terminal 102 refers to the SID and size included in a received segment and transmits an acknowledgement (ACK), as an acknowledgement for received data, including the SID of a segment which is expected to be received for the next time to the server 104. When the server 104 consecutively receives a predetermined number or larger of acknowledgements including the same SID, the server 104 retransmits segments subsequent to the SID.

A hold queue 130 in the relay device 100 is an FIFO (First In First Out) queue which holds a segment received by a reception function 112 (to be described later) until a transmission function 114 (to be described later) transmits the same. The number of FIFO queues generated is the same as the number of connections managed by a connection management function 116 (to be described later), and the FIFO queues correspond to the respective connections.

The reception function 112 receives a segment from the server 104 or the terminal 102 through the network 106, and enqueues the segment to the hold queue 130. It should be noted that when it is determined by a user management function 124 (to be described later) that the segment is not a target for traffic shaping, the transmission function 114 (to be described later) immediately transmits the segment without enqueueing the same to the hold queue.

The transmission function 114 transmits the segment received by the reception function 112 or dequeued from the hold queue 130 to the terminal 102 or the server 104 at the timing determined by a traffic shaping function 110 (to be described later).

The connection management function 116 determines whether the received segment belongs to a new connection or an established connection. Further, in the case where the received segment belongs to an existing connection, the connection management function 116 manages which connection the received segment belongs to. The function is a well-known technique, and, for example, a combination of a destination IP address, a source IP address, a destination port number, and a source port number is used for specifying the connection if TCP/IP is used as a communication protocol.

The user management function 124 determines which user the received segment belongs to, and is a well-known technique for determining whether or not the traffic shaping for communications of the user is necessary and selecting the value of shaped traffic. As a key for determining a user, for example, the source IP address of a segment is used. Information of users may be stored in the user management function 124, or may be obtained by referring to an outside database.

The traffic shaping function 110 determines the timing of transmitting the segment received by the reception function 112 or the segment held in the hold queue 130 in accordance with the shaped traffic determined by the user management function 124. The traffic shaping function 110 is a well-known technique, and, for example, a token bucket is one of algorithms for determining the transmission timing. In the embodiment, algorithms for the traffic shaping are not considered. It should be noted that the traffic shaping function 110 does not include a segment whose release flag (to be described later) is ON in the shaped traffic, and does not shape the traffic.

A next-SID prediction function 118 refers to the SID of the received segment (hereinafter, referred to as received SID) and size thereof and predicts, by calculation, the SID of another segment to be received for the next time in the communication connection of the received segment to obtain a predicated SID. The predicted SID is calculated as follows, as similar to a value included in the acknowledgement to be transmitted by the terminal 102 for the received segment in TCP.

(predicted SID)=(received SID)+(size of segment) (Equation 1)

The SID and size of a segment can be obtained from header information in, for example, TCP and UDP of communication protocols.

A predicted-SID storing function 126 stores the predicted SID calculated by the next-SID prediction function 118 for each communication connection.

A segment information storing function 120 stores a reservation flag and a release flag for each segment during a period when the segment is present in the hold queue 130. The initial values of the reservation flag and the release flag are OFF, and are changed by an SID determination function 122 (to be described later).

When the connection management function 116 determines that the segment belongs to an existing connection, the SID determination function 122 compares the received SID with the predicted SID of the same connection stored in the predicted-SID storing function 126. Any one of the following three processes is performed in accordance with the comparison result.

(1) When the received SID is smaller than the predicted SID, the release flag for releasing the traffic shaping (removing from a target for the traffic shaping) is turned on for the segment.
(2) When the received SID is larger than the predicted SID, 1 is added to the number of out-of-order SIDs stored in a function 128 for storing the number of out-of-order SIDs (to be described later), and the reservation flag used to reserve the segment as a candidate to be exempted from a target for the traffic shaping is turned on. The number of out-of-order SIDs is a new concept, and is defined as “the number of times the received SID consecutively exceeds the predicted SID in each connection”.

When the result of the addition shows that the number of out-of-order SIDs is equal to or larger than a predetermined value (for example, 2), the release flags of the segment and other segments, in the hold queue 130, whose reservation flags are ON in the same connection are turned on.

It should be noted that a relation between “the number of consecutive receptions of the same acknowledgement number” and “a predetermined value of the number of out-of-order SIDs” used when the server 104 determines that the segment has not reached the destination is defined as follows.

“a predetermined value of the number N of out-of-order SIDs”=“the number of consecutive receptions of the same acknowledgement number”−1

(3) When the received SID is equal to the predicted SID, the number of out-of-order SIDs of the same connection is set at 0, and the reservation flags of all segments of the same connection in the hold queue 130 are turned off.

The function 128 for storing the number of out-of-order SIDs stores the number of out-of-order SIDs for each connection. The initial value of the number of out-of-order SIDs in each connection is 0, and the SID determination function 122 updates the initial value.

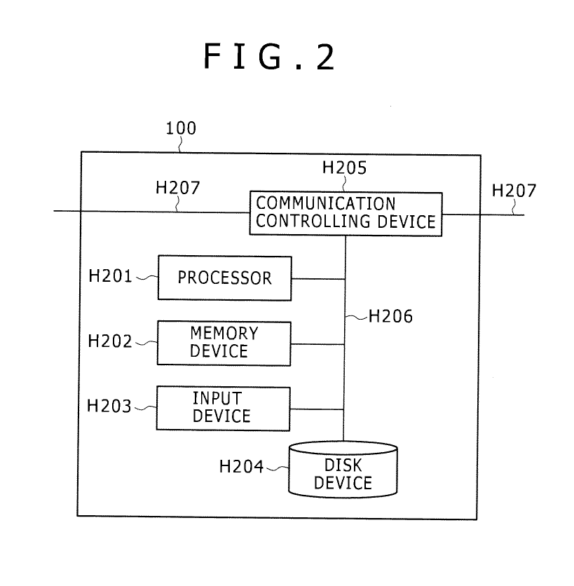

FIG. 2 is a diagram for showing a physical configuration of an electronic computer which realizes the relay device 100 of the embodiment. The relay device 100 of the embodiment includes a processor H201 which executes a program and realizes the respective functions shown in FIG. 1, a memory device H202 which temporarily holds the program to be executed and data, an input device H203 which inputs an instruction and information from outside, a disk device H204 which stores the entity of the program, the instruction, and the information and is used as a storing device of data, a communication controlling device H205 which controls transmission and reception of data between the inside of the relay device 100 and an external device, an internal communication line H206 such as a bus through which transmission and reception of data is performed inside the relay device 100, and an external communication line H207 (corresponding to the network 106 of FIG. 1) through which transmission and reception of data is performed between the inside of the relay device 100 and an external device.

The program may be preliminarily stored in the memory device H202 or the disk device H204 in the relay device 100. Alternatively, the program may be installed from a detachable storing medium which is available for the relay device 100, or may be installed from another device through a communication medium (a network, or carrier waves or digital signals propagating through a network) when it is needed.

Further, respective functions described below and the processing content thereof are realized by the processor H201 reading and executing the program stored in the disk device H204.

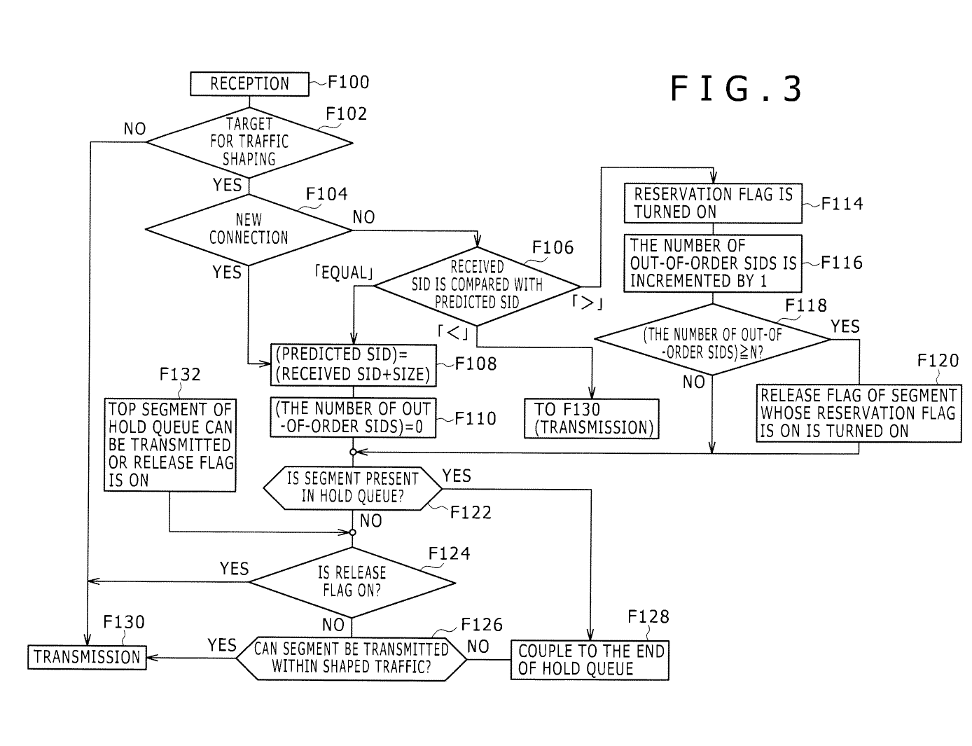

FIG. 3 is a flowchart for showing an operation in the case where the relay device 100 receives one segment.

In the first place, the reception function 112 receives a segment from the terminal 102 or the server 104 (F100).

Next, the user management function 124 determines whether or not the segment is a target for the traffic shaping on the basis of user information to which the segment belongs (F102).

When the received segment is not a target for the traffic shaping, the transmission function 114 relays the segment (F130).

When the received segment is a target for the traffic shaping, the connection management function 116 determines whether or not the segment belongs to a new connection (F104).

When the segment belongs to an established connection, the predicted SID of the same connection stored in the predicted-SID storing function 126 is compared with the received SID (F106).

When the segment belongs to a new connection or when the comparison result in F106 shows that the predicted SID is equal to the received SID, the next-SID prediction function 118 updates the value of the predicted SID (F108), sets the value of the number of out-of-order SIDS at 0, and turns off the reservation flags of all segments of the same connection in the hold queue 130 (F110).

The traffic shaping function 110 determines whether or not a previously-received segment is present in the FIFO queue of the connection to which the received segment belongs (F122). If present, the segment is enqueued to the end of the FIFO queue of the same connection (F128).

If a previously-received segment is not present in the FIFO queue of the same connection in the hold queue 130, the traffic shaping function 110 determines whether or not the release flag of the received segment is ON (F124).

If the release flag is ON (YES in F124), the traffic shaping is released (specifically, the shaped traffic is not considered), the transmission function 114 relays the segment (F130).

If the release flag is OFF, the traffic shaping function 110 determines whether or not the segment can be transmitted in the shaped traffic (F126).

If the segment can be transmitted, the transmission function 114 relays the segment (F130).

If the segment cannot be transmitted, the traffic shaping function 110 enqueues the segment to the end of the hold queue 130 (F128).

Further, when the received SID is smaller than the predicted SID in F106, the transmission function 114 relays the segment (F130).

Further, when the received SID is larger than the predicted SID in F106, the reservation flag of the segment is turned on (F114), and the value of the number of out-of-order SIDS is incremented by 1 (F116).

If the number of out-of-order SIDS is equal to or larger than a predetermined value N (for example, 2), the release flags of segments whose reservation flags are ON in the same connection in the hold queue 130 are turned on. (F120).

The subsequent processes follow those after F122.

At the same time, the traffic shaping function 110 repeatedly (for example, periodically) determines whether or not the top segment of the FIFO queue in each connection of the hold queue 130 can be transmitted in the shaped traffic, or the release flag thereof is ON (F132).

When the top segment can be transmitted or the release flag is ON, the subsequent processes follow those after F124.

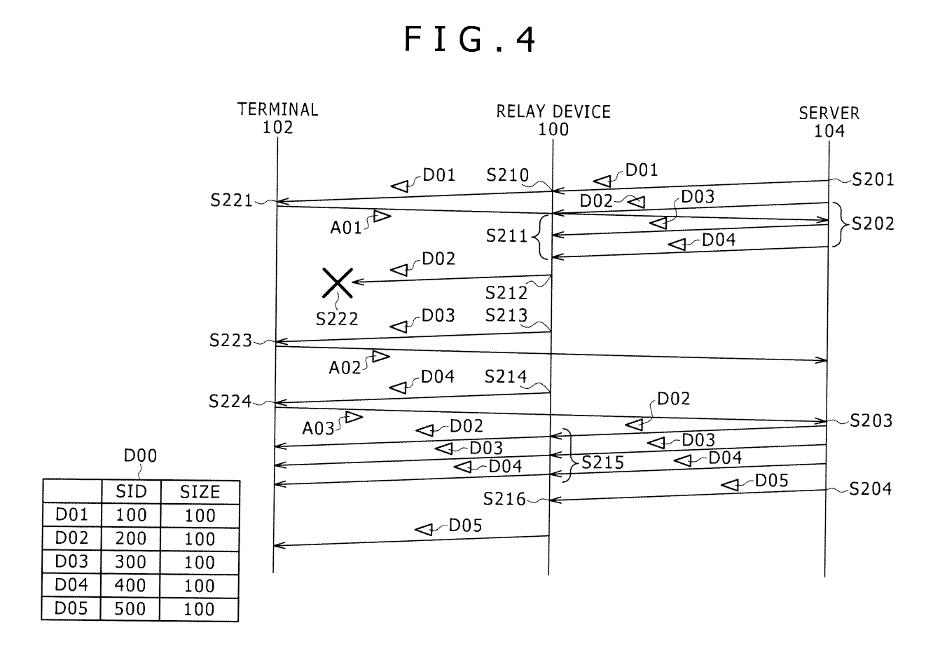

FIG. 4 shows a sequence example in the case where a segment is lost between the terminal 102 and the relay device 100 when the server 104 transmits data to the terminal 102 through the relay device 100. One connection is established in communications of FIG. 4, and the acknowledgements which are not necessary for explanation are omitted.

The reference numeral D00 denotes the SIDs and sizes of segments D01 to D04 transmitted by the server 104. If the server 104 transmits the segment D01 in a new connection, the reception function 112 of the relay device 100 receives the segment D01 (YES in F104, S201 and S210). If the traffic shaping function 110 of the relay device 100 determines that the segment D01 can be transmitted in the shaped traffic (YES in F126), the segment D01 is relayed to the terminal 102 (the processes from F108, it should be noted that the release flag is OFF, S210). Here, the next-SID prediction function 118 calculates the predicted SID as 200 using the equation 1 as shown in below (F108).

100 (received SID)+100 (size)=200

On reception of the segment D01, the terminal 102 transmits an acknowledgement A01 whose acknowledgement number is 200 to the server 104 (S221).

As similar to S201, if the server 104 transmits the segments D02, D03, and D04 (S202), the reception function 112 of the relay device 100 sequentially receives the segments (NO in F104). Since the reception SID is equal to the predicted SID (“equal” in F106), the next-SID prediction function 118 sequentially changes the predicted SIDs to 300 (200+100), 400 (300+100), and 500 (400+100) using the equation 1 (F108, S211).

If the traffic shaping function 110 determines that the segment D02 cannot be transmitted in the shaped traffic (NO in F126), the segment D02 is enqueued to the end of the hold queue (F128). Further, since the segment D02 is present in the hold queue when the segments D03 and D04 are received (F122), the segments D03 and D04 are also enqueued to the end of the hold queue (F128).

If the traffic shaping function 110 determines that the segment D02 can be transmitted in the shaped traffic after a certain period of time passes, the segment D02 is transmitted to the terminal 102 (the processes from F132, it should be noted that the release flag is OFF, S212). However, it is assumed that the segment D02 is lost between the relay device 100 and the terminal 102, and does not reach the terminal 102 (S222).

As similar to S212, when the segment D03 can be transmitted after a certain period of time passes, the relay device 100 transmits the segment D03 to the terminal 102 (the processes from F132, it should be noted that the release flag is OFF, S213).

If the terminal 102 receives the segment D03, the terminal 102 transmits an acknowledgement A02 whose acknowledgement number is 200 to the server 104 because the segment D02 has not been received (S223).

As similar to S213, when the segment D04 can be transmitted after a certain period of time passes, the relay device 100 transmits the segment D04 to the terminal 102 (the processes from F132, it should be noted that the release flag is OFF, S214).

As similar to S223, the terminal 102 transmits an acknowledgement A03 whose acknowledgement number is 200 to the server 104 because the segment D02 has not been received (S224).

If the server 104 receives the acknowledgements A02 and A03 whose acknowledgement numbers are 200, it means that the server 104 consecutively receives three acknowledgements whose acknowledgement numbers are 200 including the previously-received acknowledgement A01. Since the server 104 consecutively receives a given number (3 in the embodiment) of acknowledgements whose acknowledgement numbers are the same, it is determined that the segment (D02 in this case) corresponding to the acknowledgement number has not reached the terminal 102, and those subsequent to the segment D02 are retransmitted (S203).

The reception function 112 of the relay device 100 receives the segments 902, D03, and D04 (NO in F104). Since the SIDs of the respective segments are 200, 300, and 400 which are smaller than 500 of the latest predicted SID (“<” in F106), the SID determination function 122 determines these segments as retransmitted segments, and the transmission function 114 immediately transmits the segments without the traffic shaping for these segments (S215).

Subsequent to S203, when the server 104 transmits a segment D05 which is not for retransmission (S204) and the reception function 112 of the relay device 100 receives the segment (NO in F104), the traffic shaping function 110 relays the segment D05 in the shaped traffic (the processes from F108, it should be noted that the release flag is OFF, S216) because the received SID is 500 that is equal to the predicted SID (“equal” in F106).

As described above, when a segment is lost and retransmitted between the relay device 100 and the terminal 102 as the destination, the relay device 100 can transmit the segment in traffic closer to the expected traffic because the traffic shaping is not performed for the segment whose received SID is smaller than the predicted SID.

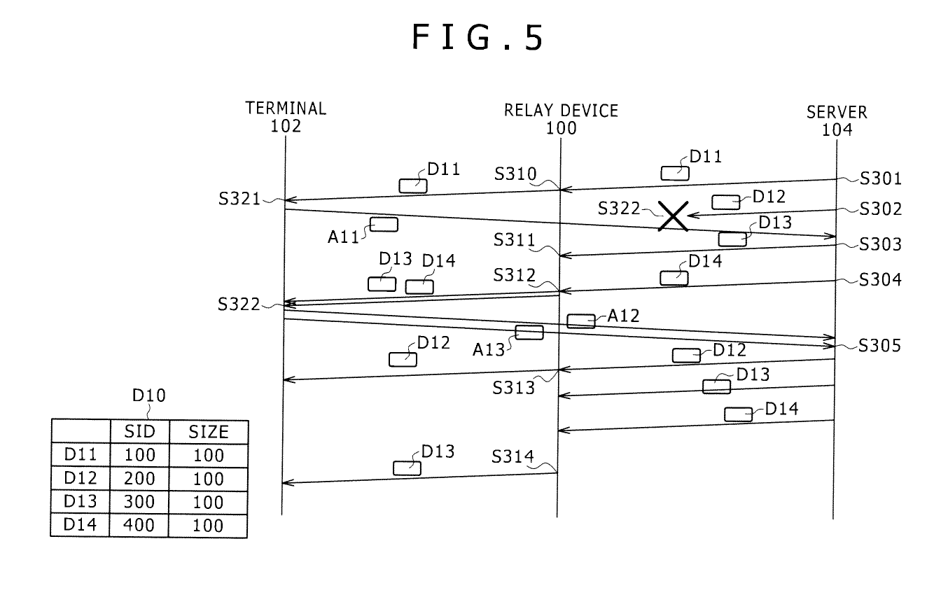

FIG. 5 shows a sequence example in the case where a segment is lost between the server 104 and the relay device 100 when the server 104 transmits data to the terminal 102 through the relay device 100. One connection is established in communications of FIG. 5, and the acknowledgements which are not necessary for explanation are omitted.

The reference numeral D10 denotes the SIDs and sizes of segments D11 to D14 transmitted by the server 104.

In the first place, if the server 104 transmits the segment D11 in a new connection (YES in F104, S301), the relay device 100 relays the segment D11 to the terminal 102 in the shaped traffic (the processes from F108, it should be noted that the release flag is OFF, S310). Here, as similar to S210 of FIG. 4, the next-SID prediction function 118 calculates the predicted SID as 200 using the equation 1.

On reception of the segment D11, the terminal 102 transmits an acknowledgement A11 whose acknowledgement number is 200 to the server 104 (S321).

Next, the server 104 transmits the segment D12 (S302). It is assumed that the segment D12 is lost before reaching the relay device 100 (S323).

As similar to S302, the server 104 transmits the segment D13 (S303).

If the reception function 112 of the relay device 100 receives the segment, the SID determination function 122 compares the predicted SID with the received SID (S313). Here, 300 as the received SID is larger than 200 as the predicted SID (“>” in F106). Accordingly, the SID determination function 122 turns on the reservation flag of the segment (F114), and the number of out-of-order SIDs is changed from 0 to 1 (F116). If N in F118 is assumed as 2 in the embodiment, (the number of out-of-order SIDs)<N is satisfied for the segment D13 (“NO” in F118), and the segment waits to be transmitted in the hold queue 130 without being immediately relayed because of the traffic shaping (F128).

Next, the server 104 transmits the segment 1914 (S304).

If the reception function 112 of the relay device 100 receives the segment D14, the SID determination function 122 compares the predicted SID with the received SID (F106, S312). Here, 400 as the received SID is larger than 200 as the predicted SID (“>” in F106). Accordingly, the SID determination function 122 turns on the reservation flag of the segment (F114), the number of out-of-order SIDs is changed from 1 to 2 (F116). Here, since the number of out-of-order SIDs becomes a predetermined value (2 in the embodiment) or larger (“YES” in F118), the release flags of segments (including those stored in the hold queue 130, namely, D13 and D14 in this case) whose reservation flags are ON are turned on (F120).

The traffic shaping function 110 does not shape the traffic for the segments D13 and D14 because the release flags of the segments D13 and D14 are ON (“YES” in F124), and the transmission function 114 transmits the segments D13 and D14 to the terminal 102 (F130). Segments to be received after D14 are similarly processed because the received SID>predicted SID is satisfied.

The terminal 102 receives not D12 but D13 and D14. Accordingly, the terminal 102 transmits acknowledgements A12 and A13 whose acknowledgement numbers are 200 to the server 104 (S322) (which is applied to segments received after D14).

If the server 104 receives the acknowledgements A12 and A13 in S305, it means that the server 104 consecutively receives the acknowledgements, including A11, whose acknowledgement numbers are 200 a given number of times (3 times in this case).

The server 104 consecutively receives the acknowledgements whose acknowledgement numbers are the same a given number of times (3 times in accordance with the above-described defined example) or more, and determines that the segment (D12 in this case) has not reached the terminal 102. Accordingly, segments after D12 are retransmitted to the terminal 102.

As for the segments D12, D13, and D14 which are received without being lost, the received SID is equal to the predicted SID. Thus, the relay device 100 transmits these segments to the terminal 102 as usual in the shaped traffic (S313 and S314).

As described above, when a segment does not reach the relay device, the traffic shaping is not performed for those to be received thereafter. Thus, the acknowledgement for the lost segment immediately reaches the server 104 from the terminal 102. As a result, the server 104 can immediately retransmit the lost segment D12 in traffic closer to the expected traffic.

According to the embodiment as described above, the relay device can shape the traffic so that the communication traffic in the transport layer is not dramatically deteriorated as compared to the shaped traffic.

Further, in the embodiment, existing devices can be used as the server 104 and the terminal 102 without the necessity of changes.

### Second Embodiment

A second embodiment is an embodiment in which when the SACK (Selective ACKnowledgement) option of TCP stipulated in RFC2018 is available and a notice of specific segments which have been transmitted and received can be given in detail in a communication connection between a terminal and a server, the communication traffic in the transport layer is prevented from being dramatically deteriorated as compared to the traffic specified by the traffic shaping.

Specifically, when consecutively receiving a predetermined number or larger of acknowledgements including the same SID, the server 104 retransmits the segment having the SID and resumes transmission from the segment subsequent to one transmitted before the retransmission, which is different from the first embodiment.

It should be noted that there will be described a case in which the SACK option of TCP is available in the embodiment. However, the embodiment can be applied to a communication protocol in which a lost segment is retransmitted and a segment which has not been lost is not retransmitted.

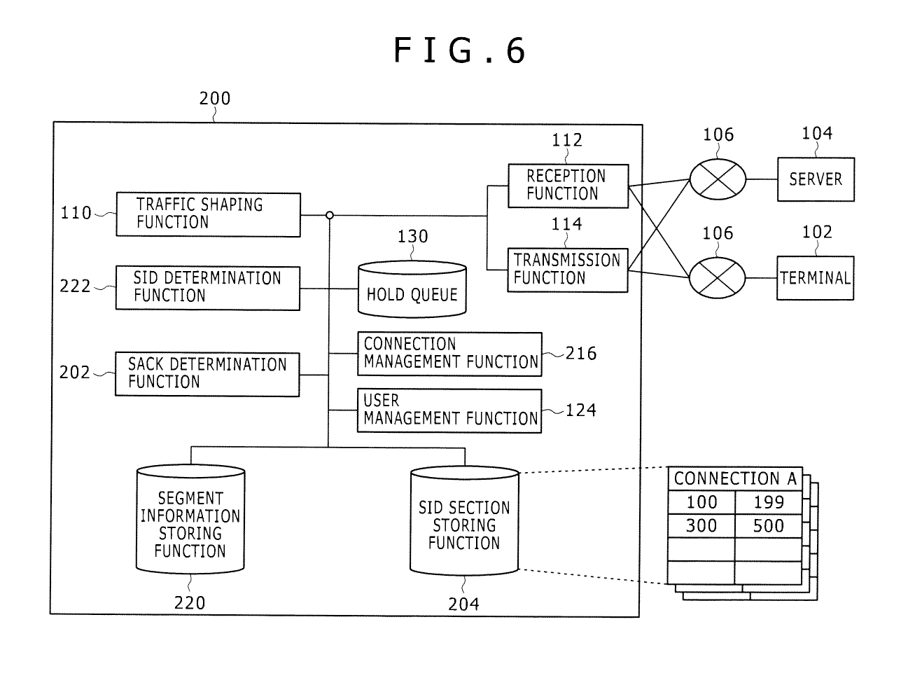

FIG. 6 shows a configuration example of a communication system according to the second embodiment. A relay device 200 includes a SACK determination function 202 and an SID section storing function 204 in addition to the functions in the relay device 100 of the first embodiment. Further, it is not necessary for the relay device 200 to include the next-SID prediction function 118, the predicted-SID storing function 126, and the function 128 for storing the number of out-of-order SIDS of the relay device 100 in the first embodiment. Further, a segment information storing function 220, a connection management function 216, and an SID determination function 222 are different from the segment information storing function 120, the SID determination function 122, and the connection management function 116 in the first embodiment, respectively.

The SACK determination function 202 determines whether or not the SACK option of the TCP protocol is available when establishing a communication connection between the server 104 and the terminal 102. The determination on whether or not the SACK option is available can be made by referring to information of the TCP header of a segment, and is a well-known technique. It should be noted that if the SACK option is available and a segment is lost, the transmission-side device does not retransmit segments which have not been lost after the lost segment.

The connection management function 216 includes, in addition to the function of the connection management function 116 of the first embodiment, a function for managing available/unavailable of the SACK option for each connection determined by the SACK determination function 202.

The SID determination function 222 calculates the range (hereinafter, referred to as received section) of a received segment on the basis of the SID and size of the received segment in each connection using an equation “(received section)=(SID of received data)+(size of received data)−1”, and the received section is coupled to the previous one.

Further, the SID determination function 222 determines whether the SID of the received segment is within or larger than the received section of the same connection. If the SID is within the received section, the segment is relayed by the transmission function 114. If the SID is larger than the received section, a priority flag (to be described later) for the segment is turned on.

The SID section storing function 204 stores the received section calculated by the SID determination function 222 for each connection.

For example, when receiving a segment having an SID of 100 and a size of 200, it is assumed that the range of the SID is 100 to 299. FIG. 6 shows an example in which the relay device 200 has already received segments having an SID of 100 to 199 and 300 to 500 in a connection A.

The segment information storing function 220 includes, in addition to the function of the segment information storing function 120 of the first embodiment, a function for storing the priority flag for each segment. The initial value of the priority flag is OFF. Further, the reservation flag stored in the segment information storing function 120 of the first embodiment is not necessary.

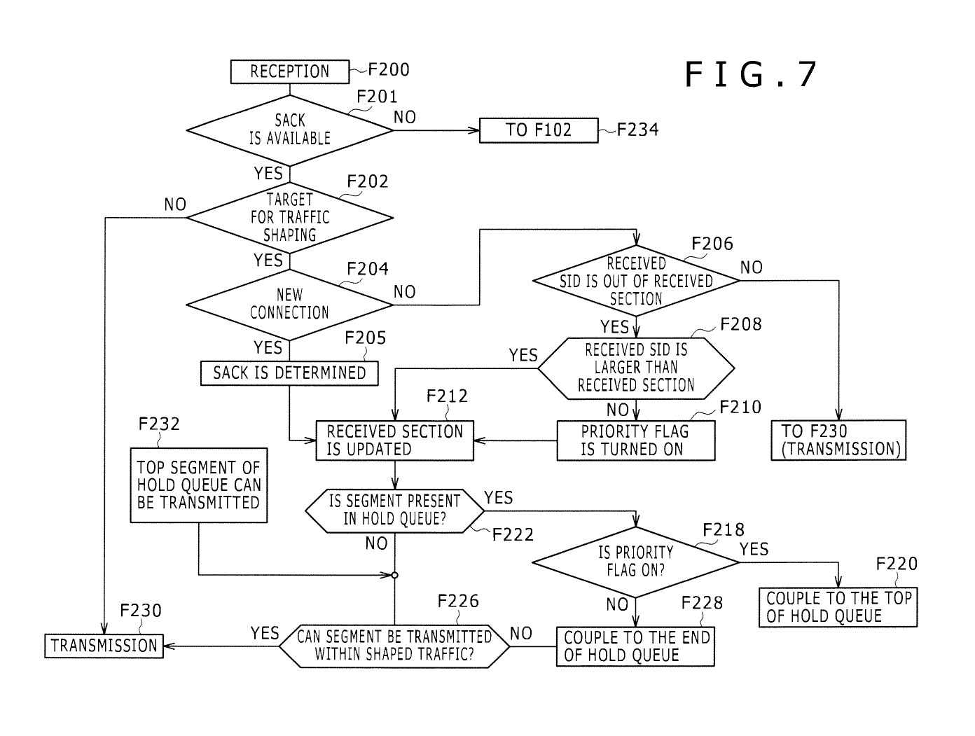

FIG. 7 is a flowchart for showing an operation in the case where the relay device 200 receives a segment.

In the first place, the reception function 112 receives a segment from the terminal 102 or the server 104 (F200).

If it is determined in F205 (to be described later) that the SACK option is not available for the connection to which the received segment belongs (NO in F201), the flowchart follows the processes of the first embodiment (the processes after F102 of FIG. 3) (F234). It should be noted that the present invention may be configured to function as an embodiment in which the transmission function 114 transmits the segment to the terminal 102 (F230), instead of the processes after F102, and the present invention may be configured to function as a conventional traffic shaping device in accordance with the processes after F222, instead of the processes after F102.

If the SACK option is available, or has not been determined yet by the SACK determination function 202 (YES in F201), the flowchart follows the processes after F202. It should be noted that if the SACK option is available, the present invention may be configured to function as an embodiment in which the transmission function 114 transmits the segment to the terminal 102 (F230), instead of the processes after F202, and the present invention may be configured to function as a conventional traffic shaping device in accordance with the processes after F222, instead of the processes after F102.

The processes of F202 and F204 are the same as those of F102 and F104 of the first embodiment, respectively.

In the case of a new connection (YES in F204), the SACK determination function 202 determines whether or not the SACK option is available on the basis of information of the TCP header of the segment (F205).

In the case of not a new connection (NO in F204), the SID determination function 222 determines whether or not the received SID is within the received section stored in the SID section storing function 204 (F206).

If the received SID is not within the received section (YES in F206), it is determined whether or not the received SID is larger than the maximum SID of the received section (F208).

If the received SID is equal to or smaller than the maximum SID of the received section (NO in F208), the priority flag of the segment is turned on (F210).

If the received SID is larger than the received section (YES in F208) after the process of F205 or F210 or in F208, the SID section storing function 204 updates the received section of the connection to which the received segment belongs. For example, in the case where a segment having an SID of 200 and a size of 50 is received when the received sections are “100 to 199 and 300 to 500” as shown in FIG. 6, the received sections are updated to “100 to 249 and 300 to 500” (F212).

If the received SID is within the received section in F206 (NO in F206), the transmission function 114 relays the segment (F230). After the process of F212, the traffic shaping function 110 determines whether or not a received segment is present in the FIFO queue of the connection to which the segment belongs (F222).

If the received segment is not present in the hold queue (NO in F222), the flowchart follows the processes after F226. The processes of F226, F228, F230, and F232 are the same as those of F126, F128, F130, and F132 of the first embodiment, respectively.

If the received segment is present in the hold queue (YES in F222), the traffic shaping function 110 determines the priority flag of the segment (F218).

If the priority flag is OFF (NO in F218), the segment is enqueued to the end of the hold queue (F228).

If the priority flag is ON (YES in F218), the segment is enqueued to the top of the hold queue (F220). It should be noted that when other segments whose priority flags are ON are already present in the hold queue, the segment is enqueued to the end of those whose priority flags are ON and the top of those whose priority flags are OFF.

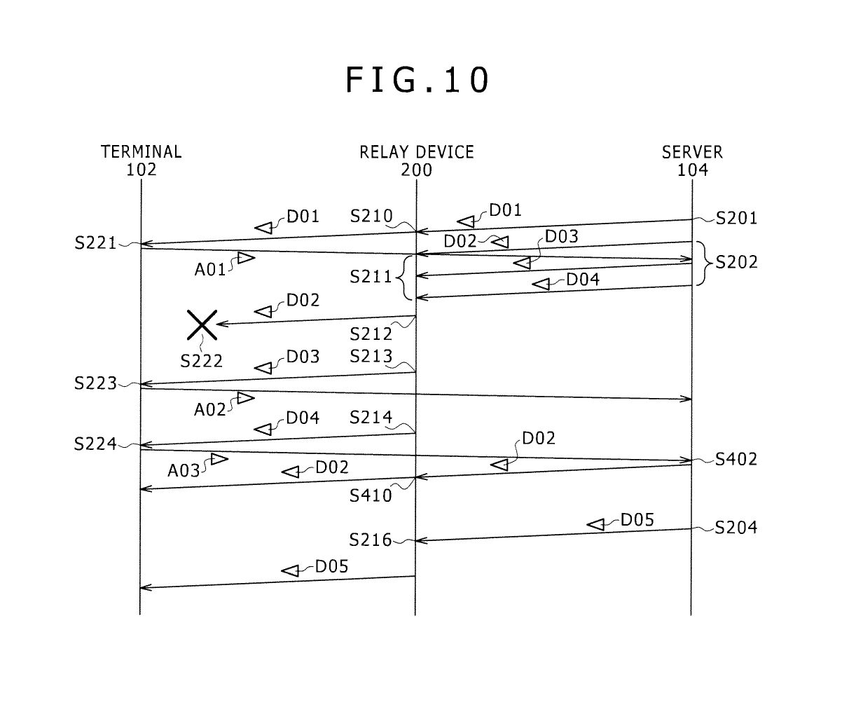

FIG. 10 shows a sequence example of the second embodiment in the case where a segment is lost between the terminal 102 and the relay device 200 when the server 104 similar to FIG. 4 transmits data to the terminal 102 through the relay device 200. One connection is established in communications of FIG. 10, and the acknowledgements which are not necessary for explanation are omitted.

FIG. 10 is different from FIG. 4 of the first embodiment in the following point. Further, the SIDs and sizes of the segments D01 to D04 transmitted by the server 104 are the same as those of D00 of the first embodiment.

When the server 104 receives the third acknowledgement A03 whose acknowledgement number is 200 and which is transmitted by the terminal 102 (S402), the server 104 retransmits the lost segment D02 but does not retransmit the already-transmitted segments D03 and D04 because the SACK option is available.

The reception function 112 of the relay device 200 receives the segment D02 retransmitted by the server 104 (S410). Since the received section stored in the SID section storing function 204 is 100 to 499 and the SID of the segment D02 is 200, the SID is within the received section (NO in F206). Accordingly, the traffic shaping function 110 does not shape the traffic of the segment D02. Thereafter, the segment D02 is transmitted to the terminal 102 as similar to the first embodiment (F230).

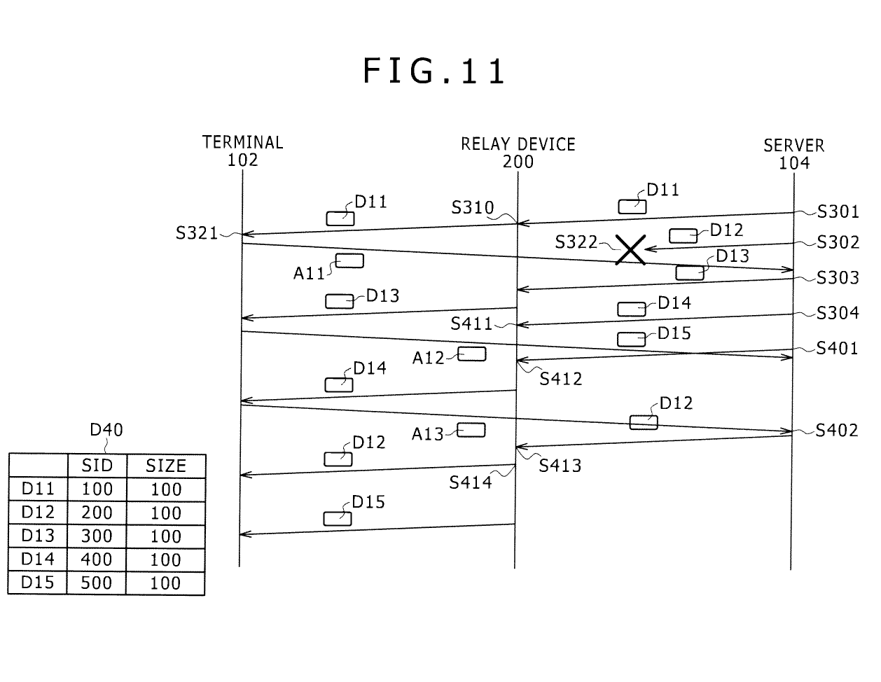

FIG. 11 shows a sequence example of the second embodiment in the case where a segment is lost between the server 104 and the relay device 200 when the server 104 similar to FIG. 5 transmits data to the terminal 102 through the relay device 200. One connection is established in communications of FIG. 11, and the acknowledgements which are not necessary for explanation are omitted.

FIG. 11 is different from FIG. 5 of the first embodiment in the following point.

The reference numeral D40 denotes the SIDs and sizes of segments D11 to D15 transmitted by the server 104. For the purpose of explanation, FIG. 11 shows an example in which the number of segments transmitted by the server 104 is larger than that shown in FIG. 5 of the first embodiment by 1.

When the reception function 112 of the relay device 200 receives the segment D14 transmitted by the server 104 (S411), the traffic shaping function 110 enqueues the segment D14 to the end of the hold queue (NO in F218, F228) because the SID of the segment D14 is larger than that of the received section and (YES in F206 and F208) and other segments are already present in the hold queue (YES in F222).

As similar to the above, when the relay device 200 receives the segment D15, the segment D15 is enqueued to the end of the hold queue (S412).

When the server 104 consecutively receives the acknowledgement A12, a given number of times (3 times in this case), whose acknowledgement number is 200 and which is transmitted by the terminal 102 in order to request the lost segment D12 as similar to the first embodiment, the server 104 retransmits the segment D12 on the basis of determination that the segment D12 has been lost (S402).

The reception function 112 of the relay device 200 receives the segment D12 (S413). Since the received sections stored in the SID section storing function 204 are 100 to 199 and 300 to 599, and the SID of the segment D12 is 200, the traffic shaping function 110 determines that the received SID is out of the received section (YES in F206) and the received SID is equal to or smaller than the received section (NO in F208). Accordingly, the priority flag is set for the segment D12 (F210), and the segment D12 is enqueued to the top of the hold queue (F220).

Although the segment D15 is already present in the hold queue prior to the segment D12, the segment D12 with the priority flag is enqueued to the queue ahead of the segment D15. Accordingly, when the segment can be transmitted after a certain period of time passes (F232), the segment D12 is transmitted earlier than the segment D15 (F230, S414).

According to the embodiment as described above, even in communications using the communication protocol in which a lost segment is retransmitted and a segment which has not been lost is not retransmitted, the relay device can shape the traffic so that the communication traffic in the transport layer is not dramatically deteriorated as compared to the shaped traffic.

### Third Embodiment

A third embodiment is an embodiment in which when a relay device 300 receives a given number or larger of segments which are not in order from the server 104, the relay device 300 does not relay the segments to the terminal 102, but responds to the server 104 to prompt to retransmit the segments.

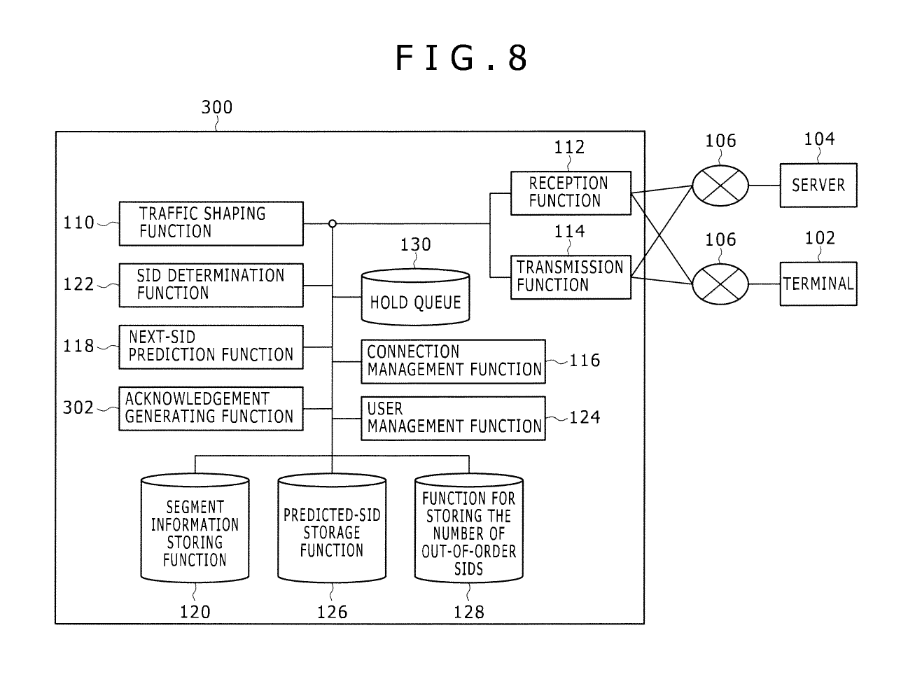

FIG. 8 shows a configuration example of a communication system of the third embodiment. The relay device 300 includes an acknowledgement generating function 302, in addition to the functions of the relay device 100 in the first embodiment.

The acknowledgement generating function 302 generates an acknowledgement for a segment received by the reception function 112. A technique for generating an acknowledgement for a segment is well known. It should be noted that as the acknowledgement number of an acknowledgement to be generated, the acknowledgement generating function 302 uses the predicted SID of the connection to which the segment belongs and which is stored in the predicted-SID storing function 126, which is different from the well-known technique.

A flowchart for showing an operation in the case where the relay device 300 receives a segment is the same as FIG. 3 of the first embodiment except F120.

In the relay device 300, the acknowledgement generating function 302 generates acknowledgements for segments which are present in the FIFO queue of the same connection stored in the hold queue 130 and whose reservation flags are ON in F120. At this time, as the acknowledgement number of each acknowledgement, the value of the predicted SID of the same connection stored in the predicted-SID storing function 126 is used.

Next, the transmission function 114 transmits the acknowledgement generated by the acknowledgement generating function 302 to the server 104. Further, the segment which corresponds to the generated acknowledgement and whose reservation flag is ON is discarded.

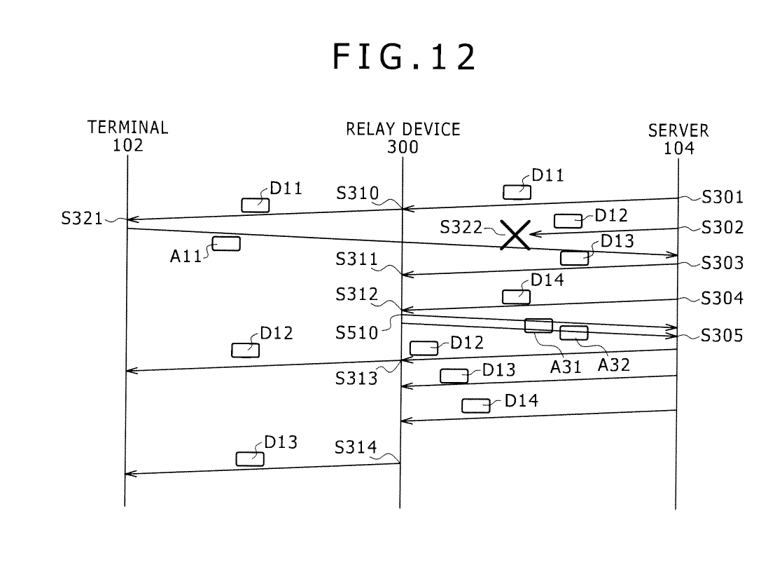

FIG. 12 shows a sequence example in the case where a segment is lost between the server 104 and the relay device 300 when the server 104 transmits data to the terminal 102 through the relay device 300.

FIG. 12 of the third embodiment is different from FIG. 5 of the first embodiment in the following point. Further, the SIDS and sizes of the segments D11 to D14 transmitted by the server 104 are the same as those of D10 of the first embodiment.

When the reception function 112 of the relay device 300 receives the segments D11, D13, and D14 except the lost segment D12 (S310 to S312), “(the number of out-of-order SIDs)≧N” where the number of out-of-order SIDs is 2 and N in F118 is 2 is satisfied (YES in F118 of FIG. 3). Accordingly, the acknowledgement generating function 302 generates, in F120 of the third embodiment, acknowledgements A31 and A32 whose acknowledgement numbers are 200 that is the predicted SID of the same connection and which correspond to D13 and D14, respectively, and responds to the server 104 (S510).

Since the server 104 consecutively receives the acknowledgements whose acknowledgement numbers are 200 a given number of times (3 times in this case), it is determined that the segment D12 has been lost, and the server 104 retransmits the segment D12 as similar to the first embodiment.

According to the embodiment as described above, when the relay device 300 receives a given number or larger of segments which are not in order, the relay device returns the acknowledgement, so that it can be expected that the segment can be more quickly retransmitted.

### Fourth Embodiment

A fourth embodiment is an embodiment in which a relay device 400 can provide new shaped traffic for a segment retransmitted by the server 104.

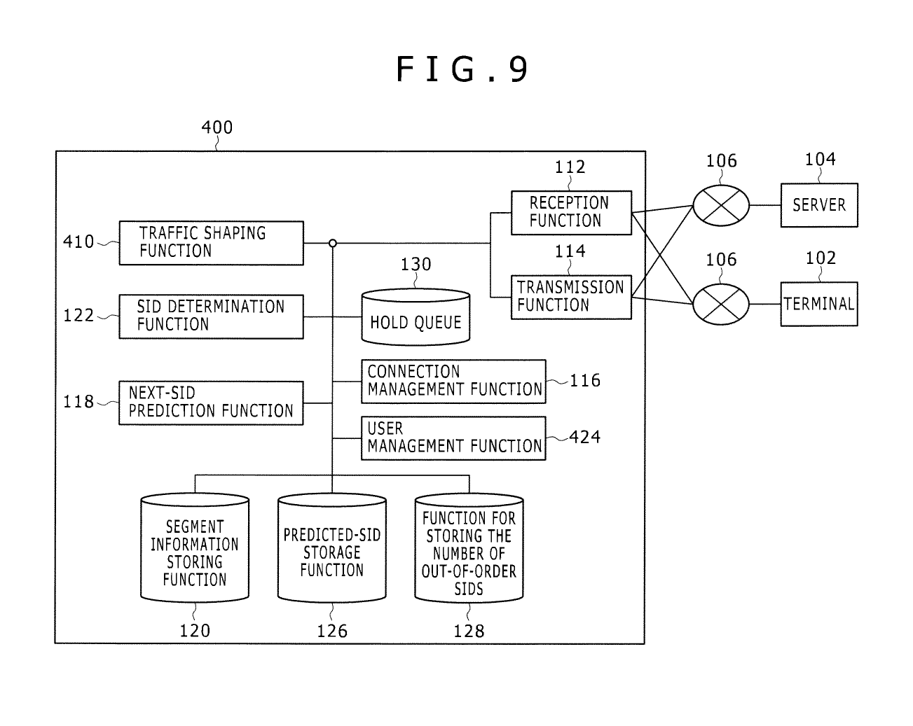

FIG. 9 is a configuration example of a communication system of the fourth embodiment. A user management function 424 and a traffic shaping function 410 of the relay device 400 are different from the corresponding functions of the relay device 100 of the first embodiment.

The user management function 424 stores the shaped traffic of a retransmitted segment for each user in addition to the function in the first embodiment. The shaped traffic of the retransmitted segment may be preliminarily set, or may be determined by the user management function 424 on the basis of the number of received SIDS of the segments received in a certain period of time in the past which are different from the predicted SID.

The traffic shaping function 410 does not release the shaped traffic of a segment whose release flag is ON, but changes to the shaped traffic of the retransmitted segment stored in the user management function 424.

A flowchart for showing an operation in the case where the relay device 400 receives a segment is the same as FIG. 3 of the first embodiment except F124 and F126.

In the relay device 400, even when the release flag is ON in F124, the flowchart does not proceed to the process of F130. If the release flag is ON in F126, the traffic shaping function 410 determines whether or not the segment can be transmitted in the shaped traffic of the retransmitted segment stored in the user management function 424.

If it is determined that the segment cannot be transmitted in the shaped traffic (NO in F126), the segment is enqueued to not the end of the hold queue but the top of the hold queue. However, if other segments whose priority flags are ON are already present in the hold queue, the segment is enqueued to the end of those whose priority flags are ON and the top of those whose priority flags are OFF.

According to the embodiment as described above, the relay device 400 can perform the traffic shaping for the segment retransmitted by the server 104.

The specification and drawings are, accordingly, to be regarded in an illustrative rather than a restrictive sense. It will, however, be evident that various modifications and changes may be made thereto without departing from the spirit and scope of the invention(s) as set forth in the claims.

What is claimed is:

1. A relay device which is provided on a network coupling a transmission-side device to a reception-side device and in which if the same SID that is order information of data in a communication connection between the transmission-side device and the reception-side device is included in a predetermined number or larger of acknowledgements which are consecutively received, the transmission-side device retransmits segments subsequent to the SID, the relay device comprising:
a reception unit which receives, from the transmission-side device, data to be transmitted to the reception-side device;
a transmission unit which transmits the data to the reception-side device;
an SID determination unit which extracts the SID included in the received data and a data size; and
a traffic shaping unit which controls the transmission unit so that the received data are transmitted to the reception-side device in predetermined traffic or smaller on a network layer in the communication connection between the transmission-side device and the reception-side device,
wherein: the traffic shaping unit calculates the SID of data that is predicted to be received for the next time as a predicted SID on the basis of the SID and the data size extracted by the SID determination unit in one communication connection, and compares the calculated predicted-SID with the SID of the data received for the next time; and
the data are exempted from a target for the traffic shaping or considered as a candidate to be exempted from a target for the traffic shaping if the calculated predicted-SID is not equal to the SID of the data received for the next time.

2. The relay device according to claim 1,
wherein: if the comparison result by the SID determination unit shows that the SID of the received data is smaller than the predicted SID, the traffic shaping unit exempts the received data from a target for the traffic shaping; and
if the comparison result by the SID determination unit shows that the SID of the received data is larger than the predicted SID, the traffic shaping unit considers the received data as a candidate to be exempted from a target for the traffic shaping.

3. The relay device according to claim 2, wherein the traffic shaping unit stores an excess number of SIDs of the received data which consecutively exceed the predicted SID, and when the excess number becomes a predetermined number or larger, the received data considered as a candidate to be exempted from a target for the traffic shaping are exempted from a target for the traffic shaping.

4. The relay device according to claim 2,
wherein: there is provided an acknowledgement generating unit which generates an acknowledgement for received data on the basis of the received data and the predicted SID;
the acknowledgement generating unit generates the acknowledgement for the received data when the number of pieces of consecutively-received data considered as candidates to be exempted from targets for the traffic shaping becomes a predetermined number or larger; and
the transmission unit discards the received data considered as candidates to be exempted from targets for the traffic shaping and transmits the acknowledgement generated by the acknowledgement generating unit to the transmission-side device.

5. A relay device which is provided on a network coupling a transmission-side device to a reception-side device and in which if the same SID that is order information of data in a communication connection between the transmission-side device and the reception-side device is included in a predetermined number or larger of acknowledgements which are consecutively received, the transmission-side device retransmits segments subsequent to the SID, the relay device comprising:
a reception unit which receives, from the transmission-side device, data to be transmitted to the reception-side device;
a transmission unit which transmits the data to the reception-side device;
an SID determination unit which extracts the SID included in the received data and a data size;
a traffic shaping unit which controls the transmission unit so that the received data are transmitted to the reception-side device in predetermined traffic or smaller on a network layer in the communication connection between the transmission-side device and the reception-side device; and
an SID section storing unit which calculates and stores the received section of the received data for each communication connection from the transmission-side device,
wherein the traffic shaping unit compares the section of the received SID with the SID of the received data to determine whether or not the received data are considered as a target for the traffic shaping on the basis of the comparison result.

6. The relay device according to claim 5, wherein the traffic shaping unit exempts the received data from a target for the traffic shaping when the SID is within the received SID section, and considers the received data as a target to be transmitted earlier than other data in the same connection and a target for the traffic shaping when the SID is not within the received SID section and is equal to or smaller than the maximum value of the received SID section.

7. The relay device according to claim 1,
wherein: new shaped traffic for data exempted from a target for the traffic shaping is stored for each sender of data; and
the data exempted from a target for the traffic shaping are transmitted in the new shaped traffic.

8. The relay device according to claim 5,
wherein: new shaped traffic for data exempted from a target for the traffic shaping is stored for each sender of data; and
the data exempted from a target for the traffic shaping are transmitted in the new shaped traffic.
